(19) United States
(12) Patent Application Publication
(10) Pub. No.: US 2020/0192149 A1
(43) Pub. Date: Jun. 18, 2020

(54) COLOR FILTER SUBSTRATE AND DISPLAY DEVICE

(71) Applicant: Wuhan China Star Optoelectronics Technology Co., Ltd., Wuhan (CN)

(72) Inventors: Fang GONG, Wuhan (CN); Heng ZHANG, Wuhan (CN); Bangrong LI, Wuhan (CN)

(73) Assignee: Wuhan China Star Optoelectronics Technology Co., Ltd., Wuhan (CN)

(21) Appl. No.: 16/470,215

(22) PCT Filed: Feb. 18, 2019
(86) PCT No.: PCT/CN2019/075310

§ 371 Date: Jun. 16, 2019

(30) Foreign Application Priority Data
Nov. 30, 2018 (CN) 201811457019.3

(51) Int. Cl. G02F 1/1335

(52) U.S. Cl. CPC G02F 1/133514; G02F 2201/52; G02F 1/133512

(57) ABSTRACT

A color filter substrate and a display device are provided. The color filter substrate includes a base substrate, a black matrix on the base substrate, and multiple pixel units arranged in the black matrix. The pixel units are arranged as multiple rows respectively. Each pixel unit includes a first sub-pixel, a second sub-pixel, and a third sub-pixel spaced from each other. Each of the first sub-pixels, the second sub-pixels, and the third sub-pixels has an opening area. Each of the pixel units of the first row and the last row is covered by the black matrix by a proportion larger than a proportion of each of the pixel units of the remaining rows covered by the black matrix.

### 1. FIELD OF DISCLOSURE

The present invention relates to a field of display devices and in particular, to a color filter substrate and a display device.

### 2. DESCRIPTION OF RELATED ART

Liquid crystal displays (LCDs) have been widely used in the field of display devices, which mainly use liquid crystal switches to adjust light intensity of a backlight source to realize a grayscale image. At the same time, a colorful image is realized by a color filter function of a color filter (CF). Conventional liquid crystal displays consist of a two-dimensional pixel array, and each pixel includes a plurality of sub-pixels of different colors, such as red (R), green (G), and blue (B), arranged in a certain order. In general, the liquid crystal display includes a black matrix (BM) and a visual area (VA), and a red (R) sub-pixel and a blue (B) sub-pixel are closest to two edges of the visual area, respectively.

When the display shows a solid red image, the middle sub-pixel mixes color with two adjacent sub-pixels to display a white color, but when the sub-pixels closest to edges of the visual area mixes color with the black matrix, the edges of the visual area are a little yellow. When the display shows a solid blue image, the sub-pixels closest to the edges of the visual area mix color with the black matrix, so the edges of the visual area are a little white. When the display shows a greyscale picture, the sub-pixels closest to the edges mix color with the black matrix, so the edges of the visual area appear red and blue lines. In addition, when panel assembly accuracy is detected on a production line, a detection screen shows a color difference at the pixel of a row closest to the edges of the visual area. That is, the left-most red sub-pixel is a little purple, and the right-most blue sub-pixel is yellowish.

### SUMMARY

When a display shows a solid red image, a middle sub-pixel mixes color with two adjacent sub-pixels to display a white color, but when sub-pixels closest to edges of a visual area mixes color with a black matrix, the edges of the visual area are a little yellow. When the display shows a solid blue image, the sub-pixels closest to the edges of the visual area mix color with the black matrix, so the edges of the visual area are a little white. When the display shows a greyscale picture, the sub-pixels closest to the edges mix color with the black matrix, so the edges of the visual area appear red and blue lines. In addition, when panel assembly accuracy is detected on a production line, a detection screen appears a color difference at the pixel of a row closest to the edges of the visual area. That is, the left-most red sub-pixel is a little purple, and the right-most blue sub-pixel is yellowish.

Accordingly, it is necessary to provide a color filter substrate and a display device to solve the existing problem of conventional techniques.

It is an objective of the present invention to provide a color filter substrate and a display device. A black matrix is used to reduce opening areas of pixel units at two side edges of a display device, thus effectively solving a problem that the pixel units at the two side edges of the display device have a color difference problem when a solid color image is displayed.

Accordingly, the present invention provides a color filter substrate, comprising: a base substrate;

a black matrix disposed on the base substrate; and a plurality of pixel units arranged in the black matrix, the pixel units being arranged as a plurality of rows respectively, and each of the pixel units comprising a first sub-pixel, a second sub-pixel, and a third sub-pixel disposed spaced from each other, wherein each of the first sub-pixels, the second sub-pixels, and the third sub-pixels comprises an opening area, each of the pixel units of the first row and the last row is covered by the black matrix by a proportion larger than a proportion of each of the pixel units of the remaining rows covered by the black matrix, and a width of the black matrix in a position corresponding to the pixel unit of the first row and a width of the black matrix in a position corresponding to the pixel unit of the last row are both greater than a width of the black matrix in a position corresponding to any of the pixel units of the remaining rows.

According to one embodiment of the present invention, the pixel unit of the first row and the pixel unit of the last row are both 10% to 40% covered by the black matrix.

According to one embodiment of the present invention, exposed from the black matrix, each of the opening areas of the sub-pixels of the pixel units of the first row and the last row is smaller than each of the opening areas of the sub-pixels of the pixel units of the remaining rows, and each of the opening areas of the sub-pixels of the pixel units of the first row and the last row is reduced by 60% to 90% compared to each of the opening areas of the sub-pixels of the pixel units of the remaining rows.

According to one embodiment of the present invention, each first sub-pixel, each second sub-pixel, and each third sub-pixel are a red (R) sub-pixel, a green (G) sub-pixel, and a blue (B) sub-pixel, respectively.

According to one embodiment of the present invention, the opening area of each of the sub-pixels is of a polygonal shape or of an irregular shape.

The present invention provides a color filter substrate, comprising:

a base substrate;

a black matrix disposed on the base substrate; and a plurality of pixel units arranged in the black matrix, the pixel units being arranged as a plurality of rows respectively, and each of the pixel units comprising a first sub-pixel, a second sub-pixel, and a third sub-pixel disposed spaced from each other, wherein each of the first sub-pixels, the second sub-pixels, and the third sub-pixels comprises an opening area, and each of the pixel units of the first row and the last row is covered by the black matrix by a proportion larger than a proportion of each of the pixel units of the remaining rows covered by the black matrix.

According to one embodiment of the present invention, the pixel unit of the first row and the pixel unit of the last row are both 10% to 40% covered by the black matrix.

According to one embodiment of the present invention, a width of the black matrix in a position corresponding to the pixel unit of the first row and a width of the black matrix in a position corresponding to the pixel unit of the last row are both greater than a width of the black matrix in a position corresponding to any of the pixel units of the remaining rows.

According to one embodiment of the present invention, exposed from the black matrix, each of the opening areas of the sub-pixels of the pixel units of the first row and the last row is smaller than each of the opening areas of the sub-pixels of the pixel units of the remaining rows, and each of the opening areas of the sub-pixels of the pixel units of the first row and the last row is reduced by 60% to 90% compared to each of the opening areas of the sub-pixels of the pixel units of the remaining rows.

According to one embodiment of the present invention, each first sub-pixel, each second sub-pixel, and each third sub-pixel are a red (R) sub-pixel, a green (G) sub-pixel, and a blue (B) sub-pixel, respectively.

According to one embodiment of the present invention, the opening area of each of the sub-pixels is of a polygonal shape or of an irregular shape.

The present invention further provides a display device, comprising:

a thin film transistor substrate;

a liquid crystal layer disposed on the thin film transistor substrate; and

a color filter substrate, the color filter substrate comprising:
a base substrate;
a black matrix disposed on the base substrate; and
a plurality of pixel units arranged in the black matrix, the pixel units being arranged as a plurality of rows respectively, and each of the pixel units comprising a first sub-pixel, a second sub-pixel, and a third sub-pixel disposed spaced from each other, wherein each of the first sub-pixels, the second sub-pixels, and the third sub-pixels comprises an opening area, and each of the pixel units of the first row and the last row is covered by the black matrix by a proportion larger than a proportion of each of the pixel units of the remaining rows covered by the black matrix.

According to one embodiment of the present invention, the display device further comprises a visual area and a border region surrounding the visual area, wherein the pixel unit of the first row and the pixel unit of the last row are disposed close to two sides of the border region.

According to one embodiment of the present invention, the pixel unit of the first row and the pixel unit of the last row are both 10% to 40% covered by the black matrix.

According to one embodiment of the present invention, a width of the black matrix in a position corresponding to the pixel unit of the first row and a width of the black matrix in a position corresponding to the pixel unit of the last row are both greater than a width of the black matrix in a position corresponding to any of the pixel units of the remaining rows.

According to one embodiment of the present invention, exposed from the black matrix, each of the opening areas of the sub-pixels of the pixel units of the first row and the last row is smaller than each of the opening areas of the sub-pixels of the pixel units of the remaining rows, and each of the opening areas of the sub-pixels of the pixel units of the first row and the last row is reduced by 60% to 90% compared to each of the opening areas of the sub-pixels of the pixel units of the remaining rows.

According to one embodiment of the present invention, each first sub-pixel, each second sub-pixel, and each third sub-pixel are a red (R) sub-pixel, a green (G) sub-pixel, and a blue (B) sub-pixel, respectively.

According to one embodiment of the present invention, the opening area of each of the sub-pixels is of a polygonal shape or of an irregular shape.

The present invention has advantages as follows. In the display device of the present invention, each of the pixel units at left and right edges of the visual area are about 10% to 40% covered by the black matrix, so that each of the opening areas of the pixel units (having the sub-pixels) at the left and right edges is reduced by 60% to 90% compared to each of the opening areas of the remaining sub-pixels, so that the pixel units at the left and right edges have smaller areas for a color mixture with the black matrix, and have a color mixture with the intermediate pixel units to cause color transitions to thereby reduce a color mixture difference. Therefore, the present invention can improve color difference problems at the edges of the visual area, and can also avoid color difference problems in left and right edges of a detection screen, thus improving display performance and quality of the display device.

### BRIEF DESCRIPTION OF DRAWINGS

In order to more clearly illustrate the embodiments of the present disclosure or related art, figures which will be described in the embodiments are briefly introduced hereinafter. It is obvious that the drawings are merely for the purposes of illustrating some embodiments of the present disclosure, and a person having ordinary skill in this field can obtain other figures according to these figures without an inventive work or paying the premise.

FIG. 1A is a cross-sectional view taken at a left-most portion of a color filter substrate and a display device according to the present invention;

FIG. 1B is a cross-sectional view taken at a right-most portion of the color filter substrate and the display device according to the present invention;

FIG. 2 is a top view illustrating the color filter substrate of the present invention; and

FIG. 3 is a schematic view illustrating the color filter substrate and the display device according to the present invention.

### DETAILED DESCRIPTION OF EMBODIMENTS

References to “embodiments” in the detailed description mean that the specific features, structures or characteristics described in connection with the embodiments may be included in at least one embodiment of the invention. The same terms mentioned in different places in the specification are not necessarily limited to the same embodiment, but should be understood as independent or alternative embodiments to other embodiments. In view of the technical solutions disclosed in the embodiments of the present invention, those skilled in the art should understand that the embodiments described herein may have other combinations or modifications in accordance with the embodiments of the present invention.

Embodiments of the present disclosure are described in detail with reference to the accompanying drawings as follows. Directional terms such as up/down, right/left and the like may be used for the purpose of enhancing a reader's understanding about the accompanying drawings, but are not intended to be limiting. Specifically, the terminologies in the embodiments of the present disclosure are merely for the purpose of describing certain embodiments, but not intended to limit the scope of the invention. The same reference numbers are used throughout the drawings to refer to the same or similar parts.

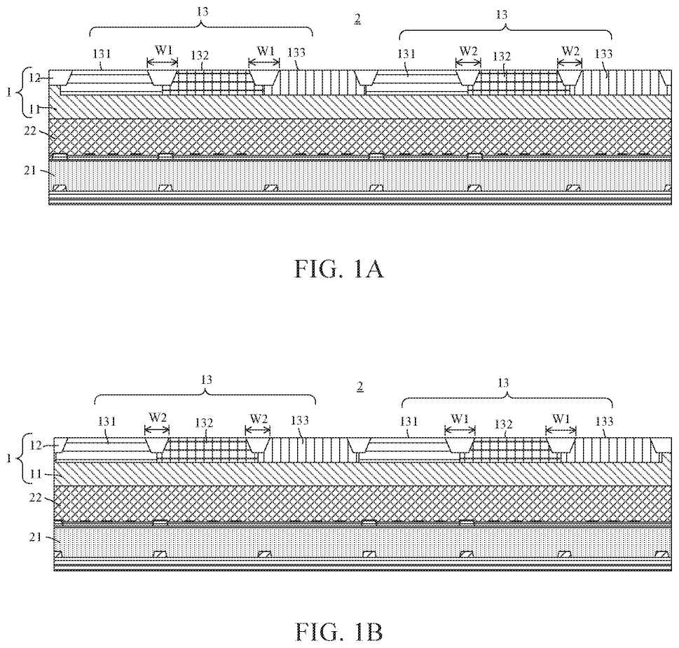

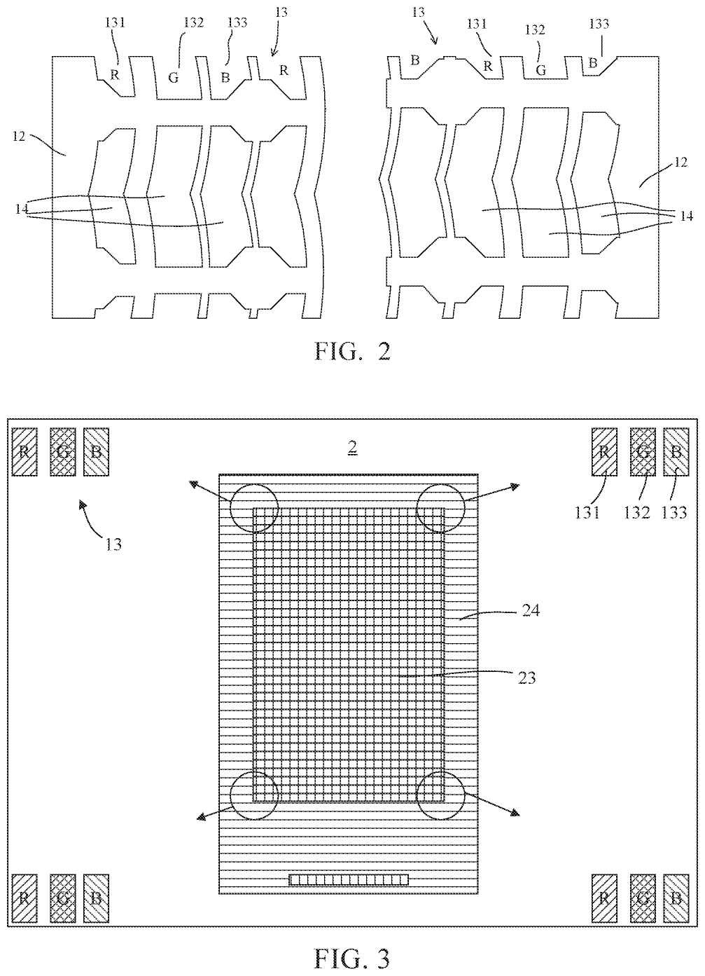

Referring to FIGS. 1A, 1B, and 2, the present invention provides a color filter substrate 1. The color filter substrate 1 comprises a base substrate 11, a black matrix (BM) 12 disposed on the base substrate 11, a plurality of pixel units 13 arranged in the black matrix 12.

The pixel units 13 are arranged as a plurality of rows and columns, perpendicular to each other, respectively. Each of the pixel units 13 comprises a first sub-pixel 131, a second sub-pixel 132, and a third sub-pixel 133 disposed spaced from each other. Referring to FIGS. 1A and 1B, the base substrate 11 is normally an over coat (OC) layer which can protect the pixel units 13 and increase smoothness of surfaces thereof. Each first sub-pixel 131, each second sub-pixel 132, and each third sub-pixel 133 are a red (R) sub-pixel, a green (G) sub-pixel, and a blue (B) sub-pixel, respectively.

Each of the first sub-pixels 131, the second sub-pixels 132, and the third sub-pixels 133 comprises an opening area 14. Each opening area 14 of each pixel unit 13 is of a polygonal shape or of an irregular shape; configuration may vary according to different designs. Each of the pixel units 13 of the first row and the last row is covered by the black matrix 12 by a proportion larger than a proportion of any of the pixel units 13 of the remaining rows, covered by the black matrix 12. In detail, each pixel unit 13 of the first row and the last row is 10% to 40% covered by the black matrix 12.

Exposed from the black matrix 12, each of the opening areas 14 of the sub-pixels 131, 132, and 133 of the pixel units 13 of the first row and the last row is smaller than each of the opening areas 14 of the sub-pixels 131, 132, and 133 of the pixel units 13 of the remaining rows, and each of the opening areas 14 of the sub-pixels 131, 132, and 133 of the pixel units 13 of the first row and the last row is reduced by 60% to 90% compared to each of the opening areas 14 of the sub-pixels 131, 132, and 133 of the pixel units 13 of the remaining rows. In other words, a width W1 of the black matrix 12 in a position corresponding to the pixel unit 13 of the first row and a width W1 of the black matrix 12 in a position corresponding to the pixel unit 13 of the last row are both greater than a width W2 of the black matrix 12 in a position corresponding to any of the pixel units 13 of the remaining rows.

By using the black matrix 12 to cover 10% to 40% of each pixel unit 13, each of the opening areas 14 of the sub-pixels 131, 132, and 133 is reduced by 60% to 90%. Therefore, the pixel units 13 of the first row and the last row have smaller areas to cause color mixture with the black matrix 12, and they mix color with the pixel units 13 of the remaining rows for making color transitions to reduce a color mixture difference. This eliminates a color difference problem in left and right side edges of a visual area when a solid color image is displayed.

Referring to FIG. 3, the present invention further provides a display device 2. The display device 2 comprises a thin film transistor substrate 21, a liquid crystal layer 22 disposed on the thin film transistor substrate 21, and the color filter substrate 1 of the above-mentioned embodiment. The color filter substrate 1 is disposed on the liquid crystal layer 22.

The embodiment shown in FIG. 3 comprises a visual area 23 and a border region 24 surrounding the visual area 23. The pixel unit 13 of the first row and the pixel unit 13 of the last row are disposed adjacent to two sides of the border region 24. The structure of the color filter substrate 1 is described in the foregoing embodiment, so a detailed description thereof is not repeated for brevity.

Furthermore, when to detect assembly precision between the color filter substrate 1 and the thin film transistor substrate 22 on a production line, the pixel units 13 adjacent to the border region 24 are 10% to 40% covered by the black matrix 12, so that the sub-pixel (R) 131 of the pixel unit 13 of the first row in a left edge of the visual area 23 and the sub-pixel (B) 133 of the pixel unit 13 of the last row in a right edge of the visual area 23 have the opening areas 14 reduced by 60% to 90%. Therefore, the pixel units 13 of the first row and the last row have smaller areas to cause color mixture with the black matrix 12, and they mix color with the intermediate pixel units 13 of the remaining rows for making color transitions to reduce a color mixture difference. Therefore, the present invention can effectively improve the color difference problems in which a screen is too purple at the left edge and too yellow at the right edge.

In the display device 2 of the present invention, the pixel units 13 at the left and right edges of the visual area 23 is about 10% to 40% covered by the black matrix 12, which causes each of the opening areas 14 of the pixel units 13 (including the sub-pixels 131, 132, and 133) at the left and right edges of the visual area 23 to be reduced by 60% to 90% compared to each of the opening areas 14 of the remaining sub-pixels 131, 132, and 133, so that the pixel units 13 at the left and right edges have smaller areas for causing color mixture with the black matrix 12, and they mix color with the intermediate pixel units 13 of the remaining rows for causing color transitions to reduce a color mixture difference, thereby improving color difference problems at edges of the visual area 23, and also avoiding color difference problems at left and right edges of a detection screen, so as to improve the display performance and quality of the display device 2.

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. A color filter substrate, comprising:
a base substrate;
a black matrix disposed on the base substrate; and
a plurality of pixel units arranged in the black matrix, the pixel units being arranged as a plurality of rows respectively, and each of the pixel units comprising a first sub-pixel, a second sub-pixel, and a third sub-pixel disposed spaced from each other, wherein each of the first sub-pixels, the second sub-pixels, and the third sub-pixels comprises an opening area, each of the pixel units of the first row and the last row is covered by the black matrix by a proportion larger than a proportion of each of the pixel units of the remaining rows covered by the black matrix, and a width of the black matrix in a position corresponding to the pixel unit of the first row and a width of the black matrix in a position corresponding to the pixel unit of the last row are both greater than a width of the black matrix in a position corresponding to any of the pixel units of the remaining rows.

2. The color filter substrate according to claim 1, wherein the pixel unit of the first row and the pixel unit of the last row are both 10% to 40% covered by the black matrix.

3. The color filter substrate according to claim 1, wherein exposed from the black matrix, each of the opening areas of the sub-pixels of the pixel units of the first row and the last row is smaller than each of the opening areas of the sub-pixels of the pixel units of the remaining rows, and each of the opening areas of the sub-pixels of the pixel units of the first row and the last row is reduced by 60% to 90% compared to each of the opening areas of the sub-pixels of the pixel units of the remaining rows.

4. The color filter substrate according to claim 1, wherein each first sub-pixel, each second sub-pixel, and each third sub-pixel are a red (R) sub-pixel, a green (G) sub-pixel, and a blue (B) sub-pixel, respectively.

5. The color filter substrate according to claim 1, wherein the opening area of each of the sub-pixels is of a polygonal shape or of an irregular shape.

6. A color filter substrate, comprising:
a base substrate;
a black matrix disposed on the base substrate; and
a plurality of pixel units arranged in the black matrix, the pixel units being arranged as a plurality of rows respectively, and each of the pixel units comprising a first sub-pixel, a second sub-pixel, and a third sub-pixel disposed spaced from each other, wherein each of the first sub-pixels, the second sub-pixels, and the third sub-pixels comprises an opening area, and each of the pixel units of the first row and the last row is covered by the black matrix by a proportion larger than a proportion of each of the pixel units of the remaining rows covered by the black matrix.

7. The color filter substrate according to claim 6, wherein the pixel unit of the first row and the pixel unit of the last row are both covered by 10% to 40% by the black matrix.

8. The color filter substrate according to claim 6, a width of the black matrix in a position corresponding to the pixel unit of the first row and a width of the black matrix in a position corresponding to the pixel unit of the last row are both greater than a width of the black matrix in a position corresponding to any of the pixel units of the remaining rows.

9. The color filter substrate according to claim 6, wherein exposed from the black matrix, each of the opening areas of the sub-pixels of the pixel units of the first row and the last row is smaller than each of the opening areas of the sub-pixels of the pixel units of the remaining rows, and each of the opening areas of the sub-pixels of the pixel units of the first row and the last row is reduced by 60% to 90% compared to each of the opening areas of the sub-pixels of the pixel units of the remaining rows.

10. The color filter substrate according to claim 6, wherein each first sub-pixel, each second sub-pixel, and each third sub-pixel are a red (R) sub-pixel, a green (G) sub-pixel, and a blue (B) sub-pixel, respectively.

11. The color filter substrate according to claim 6, wherein the opening area of each of the sub-pixels is of a polygonal shape or of an irregular shape.

12. A display device, comprising:
a thin film transistor substrate;
a liquid crystal layer disposed on the thin film transistor substrate; and
a color filter substrate, the color filter substrate comprising:
a base substrate;
a black matrix disposed on the base substrate; and
a plurality of pixel units arranged in the black matrix, the pixel units being arranged as a plurality of rows respectively, and each of the pixel units comprising a first sub-pixel, a second sub-pixel, and a third sub-pixel disposed spaced from each other, wherein each of the first sub-pixels, the second sub-pixels, and the third sub-pixels comprises an opening area, and each of the pixel units of the first row and the last row is covered by the black matrix by a proportion larger than a proportion of each of the pixel units of the remaining rows covered by the black matrix.

13. The display device according to claim 12, further comprising a visual area and a border region surrounding the visual area, wherein the pixel unit of the first row and the pixel unit of the last row are disposed close to two sides of the border region.

14. The display device according to claim 12, wherein the pixel unit of the first row and the pixel unit of the last row are both covered by 10% to 40% by the black matrix.

15. The display device according to claim 12, wherein a width of the black matrix in a position corresponding to the pixel unit of the first row and a width of the black matrix in a position corresponding to the pixel unit of the last row are both greater than a width of the black matrix in a position corresponding to any of the pixel units of the remaining rows.

16. The display device according to claim 12, wherein exposed from the black matrix, each of the opening areas of the sub-pixels of the pixel units of the first row and the last row is smaller than each of the opening areas of the sub-pixels of the pixel units of the remaining rows, and each of the opening areas of the sub-pixels of the pixel units of the first row and the last row is reduced by 60% to 90% compared to each of the opening areas of the sub-pixels of the pixel units of the remaining rows.

17. The display device according to claim 12, wherein each first sub-pixel, each second sub-pixel, and each third sub-pixel are a red (R) sub-pixel, a green (G) sub-pixel, and a blue (B) sub-pixel, respectively.

18. The color filter substrate according to claim 12, wherein the opening area of each of the sub-pixels is of a polygonal shape or of an irregular shape.
